(19) United States
(12) Patent Application Publication
(10) Pub. No.: US 2026/0333123 A1
(43) Pub. Date: Oct. 22, 2026

(54) INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN); Jianning LIU, Beijing (CN)

(73) Assignee: Beijing Xiaomi Mobile Software Co., Ltd., Beijing (CN)

(21) Appl. No.: 19/112,105

(22) PCT Filed: Sep. 16, 2022
(86) PCT No.: PCT/CN2022/119479

§ 371 Date: Mar. 14, 2025

(51) Int. Cl. H04W 28/06

(52) U.S. Cl. CPC H04W 28/06

(57) ABSTRACT

Methods, systems, and devices for information processing in a communication network. In one aspect, an application function (AF) transmits indication information to a first network function to instruct the first network function, a second network function, or both, to perform a transferring-related operation on service data based on a prediction result. The transferring-related operation includes transfer optimization, selective packet discarding, or both. The indication information may comprise requirement indication information specifying whether the transferring-related operation is needed, and/or capability indication information indicating whether the operation is supported. The first network function, which may be a policy control function (PCF) or session management function (SMF), receives the indication information and generates rule information to facilitate the transferring-related operation. The disclosed techniques enhance network efficiency by optimizing service data transfer based on predicted conditions.

### CROSS-REFERENCE TO RELATED APPLICATION

This application is a national stage of International Application No. PCT/CN2022/119479, filed on Sep. 16, 2022, which is hereby incorporated by reference in its entirety.

### TECHNICAL FIELD

The present disclosure relates to but is not limited to, the field of communication technologies, and in particular, to an information processing method and apparatus, a communication device, and a storage medium.

### BACKGROUND

Mobile media services, extended reality (XR) services such as augmented reality (AR) services or virtual reality (VR) services, cloud game services, video-based robots or unmanned aerial vehicle remote control services are expected to contribute an increasing amount of traffic to fifth generation mobile communication technology (5G) networks.

Currently, a general quality of service (QOS) mechanism is used in a 5G core network (5GC) system. Data flows of an XR service have characteristics of high bandwidth, low latency, and high-reliability requirements, and need to further match QoS requirements of a data unit (for example, a packet data unit (PDU)) and a data set in the data flow. Meanwhile, the characteristics of the high bandwidth and low latency requirements for a multimedia virtual reality (XRM) service presents a new challenge for data transferring and transmission of a radio access network (RAN) air interface.

### SUMMARY

Embodiments of the present disclosure provide an information processing method and apparatus, a communication device and a storage medium.

According to a first aspect of the embodiments of the present disclosure, an information processing method is provided, performed by an application function (AF), including:
sending indication information to a first network function, where the indication information is configured to indicate the first network function, or a second network function, or both, to perform a transferring-related operation on service data based on a prediction result; where the transferring-related operation includes transfer optimization, or selective packet discarding, or both.

In some embodiments, the indication information includes at least one of:
requirement indication information, indicating whether performing the transferring-related operation on the service data based on the prediction result is required; or
capability indication information, indicating whether performing the transferring-related operation on the service data based on the prediction result is supported.

In some embodiments, the method further includes:
receiving the capability indication information sent by a user equipment (UE);
and/or, determining the requirement indication information.

In some embodiments, sending the indication information to the first network function includes:
sending request information carrying the indication information to the first network function, where the request information further includes status information of a UE, or a parameter for determining the status information of the UE; where the status information of the UE or the parameter for determining the status information of the UE is used for updating a QoS parameter by the first network function.

In some embodiments, sending the indication information to the first network function includes at least one of:
sending the indication information to the first network function in a service specific information provisioning procedure;
sending the indication information to the first network function in an AF session establishment procedure; or
sending the indication information to the first network function in an AF session modification procedure.

In some embodiments, sending the indication information to the first network function includes:
sending the indication information to the first network function through a network exposure function (NEF).

In some embodiments, the first network function includes a policy control function (PCF) or a session management function (SMF); and/or the second network function includes a user plane function (UPF).

According to a second aspect of the embodiments of the present disclosure, an information processing method is provided, performed by an NEF, including:
receiving indication information sent by an AF, where the indication information is configured to indicate a first network function, or a second network function, or both, to perform a transferring-related operation on service data based on a prediction result; where the transferring-related operation includes transfer optimization, or selective packet discarding, or both.

In some embodiments, the method includes: sending the indication information to the first network function;

In some embodiments, the indication information includes at least one of:
requirement indication information, indicating whether performing the transferring-related operation on the service data based on the prediction result is required; or capability indication information, indicating whether performing the transferring-related operation on the service data based on the prediction result is supported.

In some embodiments, receiving the indication information sent by the AF includes:
receiving request information carrying the indication information sent by the AF;
where sending the indication information to the first network function includes:
in response to determining that a request indicated by the request information is authorized, sending the indication information to the first network function.

In some embodiments, receiving the indication information sent by the AF includes:
receiving request information carrying the indication information sent by the AF, where the request information further includes service group identifier information, or user group identifier information, or both;
the method includes: based on a case that there are more than one first network functions, determining, based on the service group identifier information, or the user group identifier information, or both, one of the first network functions to send the indication information.

In some embodiments, the method further includes at least one of:
sending the indication information to a user data repository (UDR), where the indication information is for storing by the UDR;
sending the indication information to a unified data management (UDM), where the indication information is for storing by the UDM; or
sending the indication information to an authentication server function (AUSF), where the indication information is for storing by the AUSF.

According to a third aspect of the embodiments of the present disclosure, an information processing method is provided, performed by a first network function, including:
receiving indication information sent by an AF, where the indication information is configured to indicate the first network function, or a second network function, or both, to perform a transferring-related operation on service data based on a prediction result; where the transferring-related operation includes transfer optimization, or selective packet discarding, or both.

In some embodiments, the indication information includes at least one of:
requirement indication information, indicating whether performing the transferring-related operation on the service data based on the prediction result is required; or
capability indication information, indicating whether performing the transferring-related operation on the service data based on the prediction result is supported.

In some embodiments, receiving the indication information sent by the AF includes:
receiving the indication information sent by the AF in a service specific information provisioning procedure;
receiving the indication information sent by the AF in an AF session establishment procedure; or
receiving the indication information sent by the AF in an AF session modification procedure.

In some embodiments, receiving the indication information sent by the AF includes at least one of:
receiving the indication information sent by the AF through an NEF;
receiving the indication information sent by the AF through a time sensitive communication and time synchronization function (TSCTSF); or
receiving the indication information sent by the NEF through a TSCTSF.

In some embodiments, the method includes: generating rule information based on the indication information; where the rule information is used for performing the transferring-related operation.

In some embodiments, the method includes: performing the transferring-related operation based on the rule information.

In some embodiments, the method includes at least one of:
sending the rule information to the second network function, where the rule information is configured to indicate the second network function to perform the transferring-related operation; or
sending the rule information to a radio access network function node, where the rule information is used by the radio access network function node to update a QoS parameter.

In some embodiments, the first network function includes a PCF;
generating the rule information based on the indication information includes: generating policy and charging control (PCC) rule information based on the indication information.

In some embodiments, the method includes: sending the PCC rule information to an SMF, where the PCC rule information is used by the SMF to determine QoS rule information.

In some embodiments, the first network function includes an SMF;
the method includes: generating QoS rule information mapped to the PCC rule information based on the PCC rule information; and
sending the rule information to the second network function includes: sending the QoS rule information to the second network function.

In some embodiments, receiving the indication information sent by the AF includes:
receiving request information carrying the indication information sent by the AF, where the request information further includes: status information of a UE, or a parameter for determining the status information of the UE; and
the method further includes: updating a QoS parameter based on the status information of the UE, or the parameter for determining the status information of the UE.

In some embodiments, the second network function includes a user plane function (UPF).

According to a fourth aspect of the embodiments of the present disclosure, an information processing method is provided, performed by a second network function, including:
receiving rule information sent by a first network function, where the rule information is used for performing a transferring-related operation on service data based on a prediction result; where the transferring-related operation includes transfer optimization, or selective packet discarding, or both.

In some embodiments, the method includes: performing the transferring-related operation based on the rule information.

In some embodiments, performing the transferring-related operation includes at least one of:
performing the transferring-related operation based on a granularity of a QoS flow;
performing the transferring-related operation based on a granularity of a data flow;
performing the transferring-related operation based on a granularity of a PDU set; or performing the transferring-related operation based on a granularity of a data packet.

In some embodiments, performing the transferring-related operation based on the rule information includes at least one of:
performing the transferring-related operation within a predetermined time window;
performing the transferring-related operation based on a data flow traffic being greater than a traffic threshold; or performing the transferring-related operation based on a packet error rate being greater than a packet error rate threshold.

In some embodiments, the prediction result includes a prediction analysis result of a network data analytics function (NWDAF), or an event notification result reported by a radio access network function node, or both.

In some embodiments, the first network function includes a PCF or an SMF; and/or the second network function includes a UPF.

In some embodiments, receiving the rule information sent by the first network function includes: receiving QoS rule information sent by the SMF;

performing the transferring-related operation based on the rule information includes: performing the transferring-related operation based on the QoS rule information.

According to a fifth aspect of the embodiments of the present disclosure, an information processing apparatus is provided, including:
a first sending module, configured to send indication information to a first network function, where the indication information is configured to indicate the first network function, or a second network function, or both, to perform a transferring-related operation on service data based on a prediction result; where the transferring-related operation includes transfer optimization, or selective packet discarding, or both.

In some embodiments, the indication information includes at least one of:
requirement indication information, indicating whether performing the transferring-related operation on the service data based on the prediction result is required; or
capability indication information, indicating whether performing the transferring-related operation on the service data based on the prediction result is supported.

In some embodiments, the apparatus includes:
a first receiving module, configured to receive the capability indication information sent by a user equipment (UE);
and/or, a first processing module, configured to determine the requirement indication information.

In some embodiments, the first sending module is configured to send request information carrying the indication information to the first network function, where the request information further includes status information of a UE, or a parameter for determining the status information of the UE; where the status information of the UE or the parameter for determining the status information of the UE is used for updating a QoS parameter by the first network function.

In some embodiments, the first sending module is configured to perform at least one of:
sending the indication information to the first network function in a service specific information provisioning procedure;
sending the indication information to the first network function in an AF session establishment procedure; or
sending the indication information to the first network function in an AF session modification procedure.

In some embodiments, the first sending module is configured to: send the indication information to the first network function through an NEF.

In some embodiments, the first network function includes a policy control function (PCF) or a session management function (SMF); and/or the second network function includes a user plane function (UPF).

According to a sixth aspect of the embodiments of the present disclosure, an information processing apparatus is provided, including:
a second receiving module, configured to receive indication information sent by an AF, where the indication information is configured to indicate a first network function, or a second network function, or both, to perform a transferring-related operation on service data based on a prediction result; where the transferring-related operation includes transfer optimization, or selective packet discarding, or both.

In some embodiments, the apparatus includes: a second sending module, configured to send the indication information to the first network function.

In some embodiments, the indication information includes at least one of:
requirement indication information, indicating whether performing the transferring-related operation on the service data based on the prediction result is required; or
capability indication information, indicating whether performing the transferring-related operation on the service data based on the prediction result is supported.

In some embodiments, the second receiving module is configured to receive request information carrying the indication information sent by the AF;
the second sending module is configured to: in response to determining that a request indicated by the request information is authorized, send the indication information to the first network function.

In some embodiments, the second receiving module is configured to receive request information carrying the indication information sent by the AF, where the request information further includes service group identifier information, or user group identifier information, or both;
the apparatus includes a second processing module, configured to: based on a case that there are more than one first network functions, determine, based on the service group identifier information, or the user group identifier information, or both, one of the first network functions to send the indication information.

In some embodiments, the second sending module is configured to perform at least one of:
send the indication information to a UDR, where the indication information is for storing by the UDR;
send the indication information to a UDM, where the indication information is for storing by the UDM; or
send the indication information to an AUSF, where the indication information is for storing by the AUSF;

According to a seventh aspect of the embodiments of the present disclosure, an information processing apparatus is provided, including:
a third receiving module, configured to receive indication information sent by an AF, where the indication information is configured to indicate a first network function, or a second network function, or both, to perform a transferring-related operation on service data based on a prediction result; where the transferring-related operation includes transfer optimization, or selective packet discarding, or both.

In some embodiments, the indication information includes at least one of:
requirement indication information, indicating whether performing the transferring-related operation on the service data based on the prediction result is required; or
capability indication information, indicating whether performing the transferring-related operation on the service data based on the prediction result is supported.

In some embodiments, the third receiving module is configured to perform at least one of:
receiving the indication information sent by the AF in a service specific information provisioning procedure;
receiving the indication information sent by the AF in an AF session establishment procedure; or
receiving the indication information sent by the AF in an AF session modification procedure.

In some embodiments, the third receiving module is configured to perform at least one of:
receiving the indication information sent by the AF through an NEF;
receiving the indication information sent by the AF through a TSCTSF; or
receiving the indication information sent by the NEF through a TSCTSF.

In some embodiments, the apparatus includes: a third processing module, configured to generate rule information based on the indication information; where the rule information is used for performing the transferring-related operation.

In some embodiments, the apparatus includes: a third processing module, configured to perform the transferring-related operation based on the rule information.

In some embodiments, the third sending module is configured to perform at least one of:
sending the rule information to the second network function, where the rule information is configured to indicate the second network function to perform the transferring-related operation; or
sending the rule information to a radio access network function node, where the rule information is used by the radio access network function node to update a QoS parameter.

In some embodiments, the first network function includes a PCF;
the third processing module is configured to generate PCC rule information based on the indication information.

In some embodiments, the third sending module is configured to send the PCC rule information to an SMF, where the PCC rule information is used by the SMF to determine QoS rule information.

In some embodiments, the first network function includes an SMF;
the third processing module is configured to generate QoS rule information mapped to the PCC rule information based on the PCC rule information; and the third sending module is configured to send the QoS rule information to the second network function.

In some embodiments, the third receiving module is configured to receive request information carrying the indication information sent by the AF, where the request information further includes: status information of a UE, or a parameter for determining the status information of the UE; and
the third processing module is configured to update a QoS parameter based on the status information of the UE, or the parameter for determining the status information of the UE.

In some embodiments, the second network function includes a user plane function (UPF).

According to an eighth aspect of the embodiments of the present disclosure, an information processing apparatus is provided, including:
a fourth receiving module, configured to receive rule information sent by a first network function, where the rule information is used for performing a transferring-related operation on service data based on a prediction result; where the transferring-related operation includes transfer optimization, or selective packet discarding, or both.

In some embodiments, the apparatus includes: a fourth processing module, configured to perform the transferring-related operation based on the rule information In some embodiments, the fourth processing module is configured to perform at least one of:
performing the transferring-related operation based on a granularity of a QoS flow;
performing the transferring-related operation based on a granularity of a data flow;
performing the transferring-related operation based on a granularity of a PDU set; or performing the transferring-related operation based on a granularity of a data packet.

In some embodiments, the fourth processing module is configured to perform at least one of:
performing the transferring-related operation within a predetermined time window;
performing the transferring-related operation based on a data flow traffic being greater than a traffic threshold; or
performing the transferring-related operation based on a packet error rate being greater than a packet error rate threshold.

In some embodiments, the prediction result includes a prediction analysis result of a NWDAF, or an event notification result reported by a radio access network function node, or both.

In some embodiments, the first network function includes a PCF or an SMF; and/or the second network function includes a UPF.

In some embodiments, the fourth receiving module is configured to receive QoS rule information sent by the SMF;
the fourth processing module is configured to perform the transferring-related operation based on the QoS rule information.

According to a ninth aspect of the present disclosure, a communication device is provided, including:
a processor; and
a memory for storing a processor-executable instruction;
where the processor is configured to: execute the executable instruction to implement the information processing method according to any embodiment of the present disclosure.

According to a tenth aspect of the present disclosure, a computer storage medium is provided, where the computer storage medium stores a computer-executable program, and when the executable program is executed by a processor, the information processing method of any embodiment of the present disclosure is implemented.

The technical solutions provided by the embodiments of the present disclosure may include following beneficial effects.

In the embodiments of the present disclosure, the indication information can be sent to the first network function through the AF, where the indication information is configured to indicate the first network function, or the second network function, or both, to perform the transferring-related operation on service data based on the prediction result; where the transferring-related operation includes transfer optimization, or selective packet discarding, or both. In this way, enhanced transferring on the network side of the service data may be implemented; for example, transferring of the service data may be optimized by transfer optimization, and/or network congestion may be relieved when network congestion occurs by selective packet discarding, so that service quality requirements of the service are met, and user experience is improved.

It should be understood that the above general description and the following detailed description are only examples and illustrative, and do not limit the embodiments of the present disclosure.

### BRIEF DESCRIPTION OF DRAWINGS

FIG. 1 is a schematic structural diagram of a wireless communication system according to an example embodiment.

FIG. 2 is a schematic diagram of an information processing method according to an example embodiment.

FIG. 3 is a schematic diagram of an information processing method according to an example embodiment.

FIG. 4 is a schematic diagram of an information processing method according to an example embodiment.

FIG. 5 is a schematic diagram of an information processing method according to an example embodiment.

FIG. 6 is a schematic diagram of an information processing method according to an example embodiment.

FIG. 7 is a schematic diagram of an information processing method according to an example embodiment.

FIG. 8 is a schematic diagram of an information processing method according to an example embodiment.

FIG. 9 is a schematic diagram of an information processing method according to an example embodiment.

FIG. 10 is a schematic diagram of an information processing method according to an example embodiment.

FIG. 11 is a schematic diagram of an information processing method according to an example embodiment.

FIG. 12 is a schematic diagram of an information processing method according to an example embodiment.

FIG. 13 is a block diagram of an information processing apparatus according to an example embodiment.

FIG. 14 is a block diagram of an information processing apparatus according to an example embodiment.

FIG. 15 is a block diagram of an information processing apparatus according to an example embodiment.

FIG. 16 is a block diagram of an information processing apparatus according to an example embodiment.

FIG. 17 is a block diagram of a UE according to an example embodiment.

FIG. 18 is a block diagram of a base station according to an example embodiment.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Rather, they are merely examples of apparatuses and methods consistent with some aspects of the embodiments of the present disclosure as detailed in the appended claims.

The terminology used in the embodiments of the present disclosure is for the purpose of describing particular embodiments only and is not intended to limit the embodiments of the present disclosure. The singular forms “a/an,” “the,” and “said” used in the embodiments of the present disclosure and the appended claims are also intended to include plural forms unless the context clearly indicates other meanings. It should also be understood that the term “and/or” as used herein refers to and includes any or all possible combinations of one or more associated listed item.

It should be understood that although the terms “first,” “second,” “third,” etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information,” and similarly, “second information” may also be referred to as “first information”. Depending on context, the word “if” as used herein may be interpreted as “when,” or “upon,” or “in response to determining”.

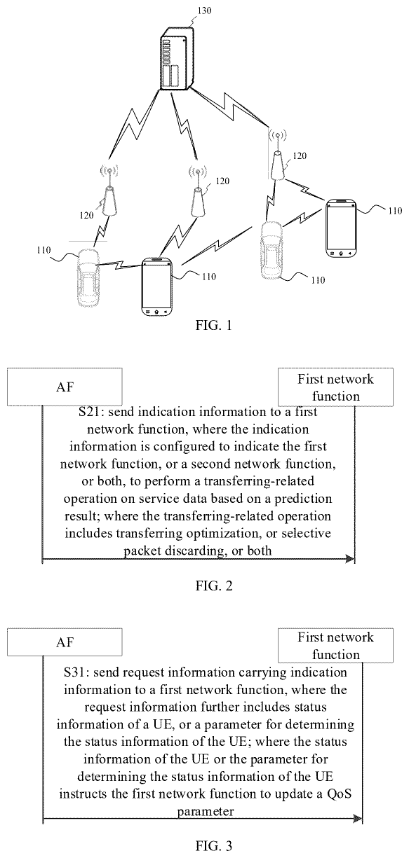

FIG. 1 is a schematic structural diagram of a wireless communication system according to an embodiment of the present disclosure. As shown in FIG. 1, a wireless communication system is a cellular mobile communication technology-based communication system, and the wireless communication system may include several pieces of user equipment 110 and several base stations 120.

The user equipment 110 may be a device that provides voice and/or data connectivity to a user. The user equipment 110 may communicate with one or more core networks through a radio access network (RAN), and the user equipment 110 may be Internet of Things user equipment, such as a sensor device, a mobile phone (or referred to as a “cellular” phone), and a computer having the Internet of Things user equipment, for example, may be a fixed, portable, pocket-sized, handheld, computer built-in, or in-vehicle apparatus. For example, a station (STA), a subscriber unit, a subscriber station, a mobile station, a mobile, a remote station, an access point, a remote terminal, an access terminal, a user terminal, a user agent, a user device, or a user equipment. Alternatively, the user equipment 110 may be a device of an unmanned aerial vehicle. Alternatively, the user equipment 110 may be an in-vehicle device, for example, may be a vehicle computer having a wireless communication function, or a wireless user equipment externally connected to a vehicle computer. Alternatively, the user equipment 110 may be a roadside device, for example, a street lamp, a signal light, or another roadside device having a wireless communication function.

The base station 120 may be a network side device in a wireless communication system. The wireless communication system may be a 4th generation mobile communication (4G) system, also referred to as a long term evolution (LTE) system; or the wireless communication system may be a 5G system, also referred to as a new radio system or a 5G NR system. Alternatively, the wireless communication system may be a next-generation system of a 5G system. Alternatively, an access network in a 5G system may be referred to as a new generation-radio access network (NG-RAN).

The base station 120 may be an evolved NodeB (eNB) used in a 4G system. Alternatively, the base station 120 may be a base station (gNB) in a centralized-distributed architecture in a 5G system. When the base station 120 uses a centralized-distributed architecture, the base station 120 usually includes a central unit (CU) and at least two distributed units (DU). The centralized unit is provided with a protocol stack of a Packet Data Convergence Protocol (PDCP) layer, a Radio Link Control (RLC) layer, and a Medium Access Control (MAC) layer; and the distributed unit is provided with a protocol stack of a Physical (PHY) layer, where a specific implementation of the base station 120 is not limited in the embodiments of the present disclosure.

A wireless connection may be established between the base station 120 and the user equipment 110 through a wireless air interface. In different implementations, the wireless air interface is a wireless air interface based on a fourth generation mobile communication network technology (4G) standard; or the wireless air interface is a wireless air interface based on a fifth generation mobile communication network technology (5G) standard, for example, the wireless air interface is a new air interface; or the wireless air interface may also be a wireless air interface based on a next generation mobile communication network technology standard of 5G.

In some embodiments, an E2E (End to End) connection may also be established between the user equipment 110. For example, in a scenario such as vehicle to vehicle (V2V) communication, vehicle to infrastructure (V2I) communication, and vehicle to peer (V2P) communication in vehicle to everything (V2X) communication.

The user equipment herein may be considered as a terminal device in the following embodiments.

In some embodiments, the wireless communication system may further include a network management device 130.

The plurality of base stations 120 are respectively connected to the network management device 130. The network management device 130 may be a core network device in a wireless communication system. For example, the network management device 130 may be a mobility management entity (MME) in an evolved packet core (EPC). Alternatively, the network management device may be another core network device, for example, a serving gateway (SGW), a public data network gateway (PGW), a policy and charging rules function (PCRF), or a home subscriber server (HSS); or the network management device may be a core network device in 5G; for example, may be a policy control function (PCF) or a session management function (SMF). An implementation form of the network management device 130 is not limited to the embodiments of the present disclosure.

For ease of understanding by those skilled in the art, the embodiments of the present disclosure list a plurality of implementations to clearly describe the technical solutions of the embodiments of the present disclosure. Certainly, those skilled in the art may understand that the multiple embodiments provided by the embodiments of the present disclosure may be executed separately, or may be executed together with the methods of other embodiments in the embodiments of the present disclosure, or may be executed separately or in combination with some methods in other related technologies; the embodiments of the present disclosure are not limited thereto.

In order to better understand the technical solution described in any embodiment of the present disclosure, the related technology is described below.

In some application scenarios, in addition to audio and video flows, an XR service further relates to a multimodal data flow, such as a biotactile data flow. These multimodal data flows represent data of a service or application input from the same device or different devices (including sensors), and these data may be output to one or more destination devices. Each data flow in the multimodal data often has a certain or even strong correlation, such as audio and video flow synchronization, or haptic and visual synchronization, etc. The data flows of such media services, among the data flows, and the requirements of these service data flows for network transmission all have some common features; effective identification and utilization of these features will be more conducive to the transmission and control of networks and services, and also to the service guarantee and user experience.

In some application scenarios, matching of QoS requirements of a PDU or a PDU set in a data flow generally refers to: a dependency relationship between data units in a data set, a dependency relationship between data sets, an importance relationship or priority of a data unit in a data set, and an importance relationship or priority of data sets.

In some application scenarios, XRM service characteristics of high bandwidth and low latency requirements present new challenges for data transferring and transmitting a RAN air interface. At present, 5G systems optimize data transfer through a RAN air interface based on information such as a dependency relationship and an important relationship or a priority between data units in a data set. However, when network congestion occurs, current data flow transferring mechanisms still cannot quickly relieve congestion, for example, a manner of discarding data units exceeding a QoS delay threshold during congestion directly leads to unsatisfied service QoS, and user experience (quality of experience, QoE) is greatly reduced. At present, a 5G system does not support an XR service data flow, especially network side transferring enhancement of a downlink flow.

As shown in FIG. 2, an embodiment of the present disclosure provides an information processing method, performed by an application function, including:
Step S21: sending indication information to a first network function, where the indication information is configured to indicate the first network function, or a second network function, or both, to perform a transferring-related operation on service data based on a prediction result; where the transferring-related operation includes transfer optimization, or selective packet discarding, or both.

In the embodiments of the present disclosure, the AF, the NEF, the first network function, the second network function, and the network data analytics function (NWDAF) or the radio access network function node in the following embodiments may all be logical nodes or functions that can be flexibly deployed in a communication network. The first network function may include a policy control function (PCF) or a session management function (SMF); and the second network function may include a user plane function (UPF).

The transferring-related operation performed on the service data based on the prediction result by the first network function and/or the second network function may include: the first network function and/or the second network function perform the transferring-related operation on the service data based on the prediction result.

In an embodiment, the prediction result may include a prediction analysis result of a NWDAF, or an event notification result reported by a radio access network function node, or both.

The prediction result herein may include any prediction result; for example, may include a network congestion result, a QoS processing result, a packet error rate or traffic of the UE, which is not limited herein.

In an embodiment, the service data may include, but is not limited to, data of at least one of: media services, XR services, cloud XR services, game services, cloud game services, video-based robot services, and unmanned aerial vehicle remote control services. The XR service may include an augmented reality (AR) service and/or a virtual reality (VR) service.

In an embodiment, the service data may include XRM service data. Certainly, in other embodiments, the service data may include data of any other service or data of a specified service, which is not limited herein.

In an embodiment, the service data may include downlink service data of a service.

Data of the service data herein may include at least one of a traffic flow, a data packet, a data packet set, a PDU, or a PDU set; and data of the service data is not limited herein.

The transfer optimization herein includes, but is not limited to, one of: transferring based on priorities of service data, transferring based on importance relationships or dependency relationships between service data.

The selective packet discarding herein includes but is not limited to one of: packet discarding on the service data within a predetermined time window, packet discarding on the service data with a traffic greater than a traffic threshold, and packet discarding on the service data with a congestion level greater than a congestion threshold.

In the embodiments of the present disclosure, the transfer optimization and the selective packet discarding may be performed in other operation manners, which are not limited herein.

In the embodiments of the present disclosure, the indication information can be sent to the first network function through the AF, where the indication information is configured to indicate the first network function, or the second network function, or both, to perform the transferring-related operation on service data based on the prediction result; where the transferring-related operation includes transfer optimization, or selective packet discarding, or both. In this way, enhanced transferring on the network side of the service data may be implemented; for example, transferring of the service data may be optimized by transfer optimization, and/or network congestion may be relieved when network congestion occurs by selective packet discarding, so that service quality requirements of the service are met, and user experience is improved.

In an embodiment, the indication information is used for performing the transferring-related operation on the service data based on the prediction result by the first network function and/or the second network function based on the rule information. The rule information may include but is not limited to at least one of policy and charging control (PCC) rule information, QoS rule information, data flow filtering rule information, usage monitoring rule information, or measurement rule information.

In some embodiments, the indication information includes requirement indication information or capability indication information, where the requirement indication information indicates whether performing the transferring-related operation on the service data based on the prediction result is required; and the capability indication information indicates whether performing the transferring-related operation on the service data based on the prediction result is supported. Alternatively, the indication information may include both the requirement indication information and the capability indication information.

In the above embodiments, the method may further include: receiving the capability indication information sent by the UE.

For example, the AF receives the capability indication information sent by the UE, where the capability indication information indicates that performing the transferring-related operation on the service data based on the prediction result is supported or not supported. If the capability indication information sent by the AF to the first network function indicates that performing the transferring-related operation on the service data based on the prediction result is supported, the first network function may perform the transferring-related operation on the service data based on the prediction result; or if the capability indication information sent by the AF to the first network function indicates that performing the transferring-related operation on the service data based on the prediction result is not supported, the first network function does not perform the transferring-related operation on the service data based on the prediction result.

In this way, in the embodiments of the present disclosure, the AF may obtain the capability indication information sent by the UE, so that the first network function and/or the second network function determine the transferring-related operation performed on the service data based on the prediction result.

In the above embodiments, the method may further include: determining the requirement indication information.

For example, the AF generates the requirement indication information, where the requirement indication information indicates whether performing the transferring-related operation on the service data based on the prediction result is required or not. If the requirement indication information sent by the AF to the first network function indicates that performing the transferring-related operation on the service data based on the prediction result is required, the first network function may perform the transferring-related operation on the service data based on the prediction result; or if the requirement indication information sent by the AF to the first network function indicates that performing the transferring-related operation on the service data based on the prediction result is not required, the first network function does not perform the transferring-related operation on the service data based on the prediction result.

In this way, in the embodiments of the present disclosure, the AF may generate the requirement indication information of the AF, so that the first network function and/or the second network function determine the transferring-related operation performed on the service data based on the prediction result.

In some embodiments, sending the indication information to the first network function in step S21 includes: sending the indication information to the first network function through an NEF.

An embodiment of the present disclosure provides an information processing method, performed by an AF, including: sending indication information to a first network function through an NEF.

Sending indication information to the first network function through the NEF by the AF may include: the AF sends the indication information to the NEF, and the NEF sends the indication information to the first network function.

In the embodiment of the present disclosure, interaction between the AF and the first network function may be transmitted by using the NEF. In this way, it is beneficial to successfully send the indication information from the AF to the first network function.

It should be noted that those skilled in the art may understand that the method provided in the embodiments of the present disclosure may be performed separately, or may be performed together with some methods in the embodiments of the present disclosure or some methods in related technologies.

In some embodiments, in step S21, the indication information may be sent to the first network function through request information. The request information further includes status information of a UE, or a parameter for determining the status information of the UE, and the request information is configured to indicate the first network function to update a QoS parameter based on the status information of the UE.

In an implementation, the request information may include the indication information; or the request information may include the status information of the UE, or the parameter for determining the status information of the UE; or the request information may include the indication information, and may also include the status information of the UE or the parameter for determining the status information of the UE.

In an implementation, the request information may include the indication information, and may further include the status information of the UE or the parameter for determining the status information of the UE. An embodiment is provided below to describe the implementation. As shown in FIG. 3, an embodiment of the present disclosure provides an information processing method, performed an AF, including:
Step S31: sending request information carrying indication information to a first network function, where the request information further includes status information of a UE, or a parameter for determining the status information of the UE; where the status information of the UE or the parameter for determining the status information of the UE is configured to indicate the first network function to update a QoS parameter.

The indication information is described in other embodiments, and details will not be repeated herein.

In an implementation, the request information may include the status information of the UE or the parameter for determining the status information of the UE, and the request information may not include the indication information. An embodiment is provided below to describe the implementation. An embodiment of the present disclosure provides an information processing method, performed by an AF, including: sending status information of a UE or a parameter for determining the status information of the UE to a first network function, where the status information of the UE or the parameter for determining the status information of the UE is configured to indicate the first network function to update a QoS parameter according to the status information of the UE.

It should be noted that the request information may not include the indication information, but includes the status information of the UE or the parameter for determining the status information of the UE.

In a possible implementation, the indication information may not be sent, or the indication information may be sent in another manner.

In the above embodiments of the present disclosure, the first network function and the second network function can be referred from any embodiment of the present disclosure; for example, the first network function may include a PCF or an SMF; and the second network function may include a UPF. In some embodiments of the present disclosure, the indication information may be the indication information in any embodiment of the present disclosure. As described above, for example, the indication information may include the requirement indication information and/or the capability indication information.

In an embodiment, the status information of the UE may include, but is not limited to, at least one of: overheating information for indicating overheating of the UE, information for indicating a power mode, and information for indicating GPU (graphics processing unit) load balancing. Certainly, in other embodiments, the status information of the UE may be any information describing that the UE is in a certain status, and the status of the UE is not limited herein. Specifically, the indication information with one or more bits may be used to indicate the overheating information of the UE.

In an embodiment, the parameter for determining the status information of the UE refers to that the status information of the UE can be determined according to the parameter.

In an embodiment, the QoS parameter may include, but is not limited to, at least one of:
PDU Set handling indication, where the PDU Set handling indication indicates whether PDU Set based handling should be activated to a data flow;
a parameter indicating whether all PDUs are needed for the usage of PDU Set by application layer;
PDU Set Delay Budget (PSDB); or PDU Set Error Rate;
a parameter indicating whether to discard a PDU Set in case PSDB is exceeded; or PDU Set priority or PDU priority.

In this way, in the embodiments of the present disclosure, the AF may send the status information of the UE or the parameter for determining the status information of the UE to the first network function, so that the first network function can update the QoS parameter. In such way, it is beneficial for the first network function to determine the QoS parameter for determining the rule information according to an actual status of the UE.

It should be noted that those skilled in the art may understand that the method provided in the embodiments of the present disclosure may be performed separately, or may be performed together with some methods in the embodiments of the present disclosure or some methods in related technologies.

In some embodiments, sending the indication information to the first network function in step S21 includes at least one of:
sending the indication information to the first network function in a service specific information provisioning procedure;
sending the indication information to the first network function in an AF session establishment procedure; or sending the indication information to the first network function in an AF session modification procedure.

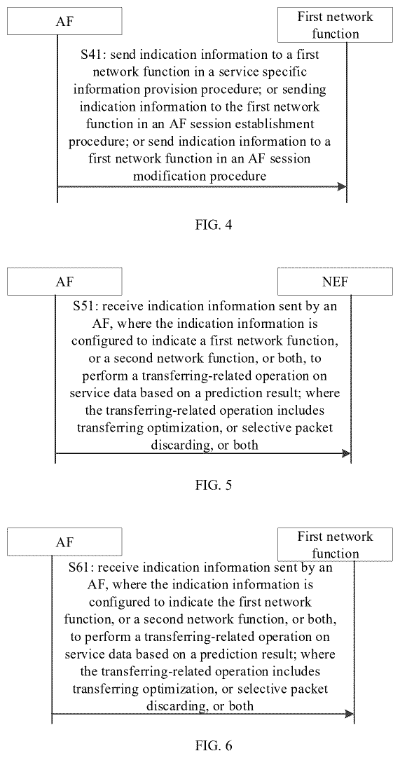

Namely, as shown in FIG. 4, an embodiment of the present disclosure provides an information processing method, performed by an AF.
Step S41: sending indication information to a first network function in a service specific information provision procedure; or sending indication information to the first network function in an AF session establishment procedure; or sending indication information to a first network function in an AF session modification procedure.

The service specific information herein includes at least one of: status information of the UE, a parameter for determining the status information of the UE, service group identifier information, user group identifier information, service identifier information or user identifier information. The service group identifier information herein is used to uniquely identify the identifier information of the service group; and the service identifier information is used to uniquely identify the identifier of the service. The user group identifier information herein is used to uniquely identify identifier information of a user group; and the user identifier information is used to uniquely identify identifier information of a user.

The service specific information provision procedure may include a procedure in which the AF provides the service specific information to the PCF.

For example, in the service specific information provision procedure, the AF may send an AF request carrying the indication information to the first network function. Alternatively, in the AF session establishment procedure, the AF may send a session establishment request carrying the indication information to the first network function. Alternatively, in the AF session modification procedure, the AF may send a session modification request carrying the indication information to the first network function.

In the embodiments of the present disclosure, the request carrying the indication information may be sent in the service specific information procedure, the AF session establishment procedure or the AF session modification procedure, so that two functions may be implemented through one request. In such way, usage of the signaling is improved, and cost of the signaling is saved.

It should be noted that those skilled in the art may understand that the method provided in the embodiments of the present disclosure may be performed separately, or may be performed together with some methods in the embodiments of the present disclosure or some methods in related technologies.

The following information processing method is performed by an NEF, and is similar to the description of the information processing method performed by the AF; and for technical details not disclosed in the embodiment of the information processing method performed by the NEF, the description of the example of the information processing method performed by the AF can be referred to, and details will not be described herein.

As shown in FIG. 5, an embodiment of the present disclosure provides an information processing method, performed by an NEF, including:
Step S51: receiving indication information sent by an AF, where the indication information is configured to indicate a first network function, or a second network function, or both, to perform a transferring-related operation on service data based on a prediction result; where the transferring-related operation includes transfer optimization, or selective packet discarding, or both.

In some embodiments of the present disclosure, the first network function and the second network function are respectively the first network function and the second network function in the above embodiments; the prediction result, the indication information and the service data are respectively the prediction result, the indication information and the service data in the above embodiments; and the transfer optimization and the selective packet discarding are respectively the transfer optimization and the selective packet discarding in the above embodiments.

For example, the first network function includes a PCF or an SMF, and the second network function includes a UPF.

For example, the prediction result may include a prediction analysis result of a NWDAF, or an event notification result reported by a radio access network function node, or both.

For example, the indication information includes at least one of:
requirement indication information, indicating whether performing the transferring-related operation on the service data based on the prediction result is required; or
capability indication information, indicating whether performing the transferring-related operation on the service data based on the prediction result is supported.

An embodiment of the present disclosure provides an information processing method, performed by an NEF, including: sending indication information to a first network function.

For details of the above implementation, reference may be made to the description on the AF side, and details will not be repeated herein.

In some embodiments, receiving the indication information sent by the AF in step S51 includes: receiving request information carrying the indication information sent by the AF;
sending the indication information to the first network function includes: sending the indication information to the first network function in response to determining that a request indicated by the request information is authorized.

According to an embodiment of the present disclosure, an information processing method is provided, performed by an NEF, including:
receiving request information carrying the indication information sent by the AF;
in response to determining that a request indicated by the request information is authorized, sending the indication information to the first network function.

If the NEF authorizes the request indicated by the request information sent by the AF, the NEF sends the indication information to the first network function; or if the NEF does not authorize the request indicated by the request information sent by the AF, the NEF does not send the indication information to the first network function.

In some embodiments, receiving the indication information sent by the AF in step S51 includes:
receiving request information carrying the indication information sent by the AF, where the request information further includes service group identifier information, or user group identifier information, or both;
the method includes: based on a case that there are more than one first network functions, determining, based on the service group identifier information, or the user group identifier information, or both, one of the first network functions to send the indication information.

According to an embodiment of the present disclosure, an information processing method is provided, performed by an NEF, including:
receiving service group identifier information, or user group identifier information, or both, sent by an AF; and
based on a case that there are more than one first network functions, determining, based on the service group identifier information, or the user group identifier information, or both, one of the first network functions to send the indication information.

For example, when there are multiple PCFs or multiple UEs are involved, a PCF corresponding to the service group identifier information or a PCF corresponding to the user group identifier may be determined, and the indication information is sent to the corresponding PCF. In this way, the one of the multiple associated PCFs corresponding to the service data may be identified by using the service group identifier information and/or the service group identifier information, so that an appropriate PCF is selected to send the indication information. In the embodiments of the present disclosure, “multiple” refers to “two or more”.

An embodiment of the present disclosure provides an information processing method, performed by an NEF, including at least one of:
send the indication information to a UDR, where the indication information is for storing by the UDR;
send the indication information to a UDM, where the indication information is for storing by the UDM; or
send the indication information to an AUSF, where the indication information is for storing by the AUSF.

In this way, in the embodiments of the present disclosure, the NEF may send the indication information to at least one of the UDR, the UDM, or the AUSF, so that at least one of the UDR, the UDM, or the AUSF may store the indication information.

In addition, the indication information may alternatively be stored as an AMF (Access and Mobility Management Function)-associated parameter, or stored as an SMF-associated parameter, and/or stored as a characteristic parameter of application time service.

For details of the above implementation, reference may be made to the description on the AF side, and details will not be repeated herein.

It should be noted that those skilled in the art may understand that the method provided in the embodiments of the present disclosure may be performed separately, or may be performed together with some methods in the embodiments of the present disclosure or some methods in related technologies.

The following information processing method is performed by the first network function, and is similar to the description of the information processing method performed by the AF and/or the NEF; and for technical details not disclosed in the embodiment of the information processing method performed by the first network function, the description of the example of the information processing method performed by the AF and/or the NEF can be referred to, and details will not be described herein.

As shown in FIG. 6, an embodiment of the present disclosure provides an information processing method, performed by a first network function, including:
Step S61: receiving indication information sent by an AF, where the indication information is configured to indicate the first network function, or a second network function, or both, to perform a transferring-related operation on service data based on a prediction result; where the transferring-related operation includes transfer optimization, or selective packet discarding, or both.

In some embodiments of the present disclosure, the first network function and the second network function are respectively the first network function and the second network function in the above embodiments; the prediction result, the indication information and the service data are respectively the prediction result, the indication information and the service data in the above embodiments; and the transfer optimization and the selective packet discarding are respectively the transfer optimization and the selective packet discarding in the above embodiments.

For example, the first network function includes a PCF or an SMF, and the second network function includes a UPF.

For example, the prediction result may include a prediction analysis result of a NWDAF, or an event notification result reported by a radio access network function node, or both.

For example, the indication information includes at least one of:
requirement indication information, indicating whether performing the transferring-related operation on the service data based on the prediction result is required; or
capability indication information, indicating whether performing the transferring-related operation on the service data based on the prediction result is supported.

In some embodiments, receiving the indication information sent by the AF in step S61 includes:
receiving the indication information sent by the AF in a service specific information provisioning procedure;
receiving the indication information sent by the AF in an AF session establishment procedure; or
receiving the indication information sent by the AF in an AF session modification procedure.

An embodiment of the present disclosure provides an information processing method, performed by a first network function, including:
receiving the indication information sent by the AF in a service specific information provisioning procedure;
receiving the indication information sent by the AF in an AF session establishment procedure; or
receiving the indication information sent by the AF in an AF session modification procedure.

In some embodiments, receiving the indication information sent by the AF in step S61 includes: receiving the indication information sent by the AF through an NEF.

An embodiment of the present disclosure provides an information processing method, performed by a first network function and including: receiving the indication information sent by the AF through the NEF.

In some embodiments, receiving the indication information sent by the AF in step S61 includes:
receiving request information carrying the indication information sent by the AF, where the request information further includes: status information of a UE, or a parameter for determining the status information of the UE; and
the method further includes: updating a QoS parameter based on the status information of the UE, or the parameter for determining the status information of the UE.

An embodiment of the present disclosure provides an information processing method, performed by a first network function, including:
receiving request information carrying the indication information sent by the AF, where the request information further includes: status information of a UE, or a parameter for determining the status information of the UE; and
updating a QoS parameter based on the status information of the UE, or the parameter for determining the status information of the UE.

Updating the QoS parameter based on the parameter for determining the status information of the UE may include: determining the status information of the UE based on the parameter for determining the status information of the UE; and updating the QoS parameter based on the status information of the UE.

For details of the above implementation, reference may be made to the description on the AF and/or NEF side, and details will not be repeated herein.

In some embodiments, receiving the indication information sent by the AF in step S61 includes at least one of:
receiving the indication information sent by the AF through a TSCTSF; or receiving the indication information sent by the NEF through a TSCTSF.

An embodiment of the present disclosure provides an information processing method, performed by a first network function, including: receiving indication information sent by an AF through a TSCTSF; or receiving indication information sent by an NEF through a TSCTSF.

The first network function receives the indication information sent by the AF through the TSCTSF may include: the first network function receives the indication information sent by the TSCTSF, where the indication information is sent by the AF.

The first network function receives the indication information sent by the NEF through the TSCTSF may include: the first network function receives the indication information sent by the TSCTSF, where the indication information is sent by the NEF.

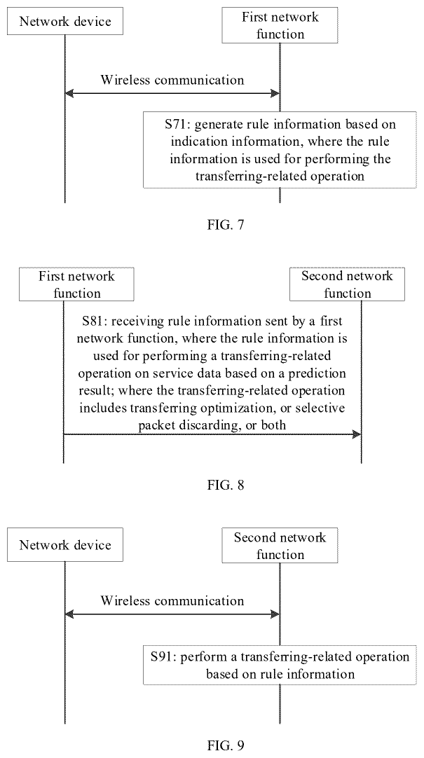

As shown in FIG. 7, an embodiment of the present disclosure provides an information processing method, performed by a first network function, including:
Step S71: generating rule information based on indication information, where the rule information is used for performing the transferring-related operation.

An embodiment of the present disclosure provides an information processing method, performed by a first network function and including: performing the transferring-related operation based on the rule information.

An embodiment of the present disclosure provides an information processing method, performed by a first network function, including at least one of:
sending the rule information to the second network function, where the rule information is configured to indicate the second network function to perform the transferring-related operation; or
sending the rule information to a radio access network function node, where the rule information is used by the radio access network function node to update a QoS parameter.

In an embodiment, the rule information may be the rule information in the above embodiments. For example, the rule information may be the PCC rule information.

In some embodiments, the first network function includes a PCF;
generating the rule information based on the indication information includes: generating the PCC rule information based on the indication information.

According to an embodiment of the present disclosure, an information processing method is provided, performed by a PCF, including:
generating the PCC rule information based on the indication information; and performing the transferring-related operation based on the PCC rule information.

For example, the first network function receives the indication information from the AF, where the indication information includes capability indication information, and the capability indication information indicates that a transferring-related operation is supported to be performed on service data based on a prediction result; the prediction result is that a congestion event occurs; and the first network function may perform the transferring-related operation based on the PCC rule information corresponding to the indication information, and perform the transferring-related operation based on the PCC rule information.

An embodiment of the present disclosure provides an information processing method performed by a PCF, including: sending PCC rule information to an SMF, where the PCC rule information is used by the SMF to determine QoS rule information.

In an embodiment, sending the rule information to the second network function includes: sending the QoS rule information to the second network function, where the QoS rule is used by the second network function to perform the transferring-related operation on service data based on the prediction result.

According to an embodiment of the present disclosure, an information processing method is provided, performed by an SMF, including:
generating QoS rule information mapped to the PCC rule information based on the PCC rule information; and
sending the QoS rule information to the second network function.

The QoS rule information herein may indicate a QoS rule of a data flow or a QoS rule of a QOS flow.

An embodiment of the present disclosure provides an information processing method performed by an SMF, including: sending at least one of data flow filtering rule information, usage monitoring rule information and measurement rule information to the second network function.

For example, after receiving the indication information, the PCF generates the PCC rule information based on the indication information; and the PCF sends the PCC rule information to the SMF. The SMF maps the PCC rule information to corresponding QoS rule information; and the SMF sends the QoS rule information, the data flow filtering rule information, the usage monitoring rule information, and/or the measurement rule information to the UPF, so that the UPF installs the rule information and performs a corresponding transferring-related operation.

In this way, in the embodiments of the present disclosure, the PCF may generate the PCC rule information based on the indication information, and determine, based on the PCC rule information, a to-be-performed transferring-related operation, so that enhanced transferring on the network side of the service data can be implemented, and inaccurate charging caused by packet discarding in transfer optimization on the network side can be reduced.

In addition, the SMF may determine the mapped QoS rule information based on the PCC rule information, and send the QoS rule information to the second network function, so that the second network function may perform a proper transferring-related operation.

In some embodiments of the present disclosure, the PCF and the SMF may be deployed simultaneously; or the SMF may be deployed; or the PCF may be integrated in the SMF. When no PCF is deployed, the transferring-related operation may be performed based on the SMF based on the rule information.

For details of the above implementation, reference may be made to the description on the AF and/or NEF side, and details will not be repeated herein.

It should be noted that those skilled in the art may understand that the method provided in the embodiments of the present disclosure may be performed separately, or may be performed together with some methods in the embodiments of the present disclosure or some methods in related technologies.

The following information processing method is performed by the second network function, and is similar to the description of the information processing method performed by the AF and/or the NEF and/or the first network function; and for technical details not disclosed in the embodiment of the information processing method performed by the second network function, the description of the example of the information processing method performed by the AF and/or the NEF and/or the first network function can be referred to, and details will not be described herein.

As shown in FIG. 8, an embodiment of the present disclosure provides an information processing method, performed by a second network function, including:
Step S81: receiving rule information sent by a first network function, where the rule information is used for performing a transferring-related operation on service data based on a prediction result; where the transferring-related operation includes transfer optimization, or selective packet discarding, or both.

In some embodiments of the present disclosure, the first network function and the second network function are respectively the first network function and the second network function in the above embodiments; the prediction result and the service data are respectively the prediction result and the service data in the above embodiments; the transfer optimization and the selective packet discarding are respectively the transfer optimization and the selective packet discarding in the above embodiments; and the rule information may be the rule information in the above embodiments.

For example, the first network function includes a PCF, and the second network function includes a UPF.

For example, the prediction result may include a prediction analysis result of a NWDAF, or an event notification result reported by a radio access network function node, or both.

For example, the rule information may include but is not limited to at least one of PCC rule information, QoS rule information, data flow filtering rule information, usage monitoring rule information, or measurement rule information.

In an embodiment, the rule information is determined by the first network function based on the received indication information.

For example, the indication information includes at least one of:
requirement indication information, indicating whether performing the transferring-related operation on the service data based on the prediction result is required; or
capability indication information, indicating whether performing the transferring-related operation on the service data based on the prediction result is supported.

As shown in FIG. 9, an embodiment of the present disclosure provides an information processing method, performed by a second network function, including:
Step S91: performing a transferring-related operation based on rule information.

In some embodiments, receiving the rule information sent by the first network function in step S81 includes: receiving QoS rule information sent by the SMF;
step S91 includes: performing the transferring-related operation based on the QoS rule information.

An embodiment of the present disclosure provides an information processing method, performed by a second network function, including:
receiving QoS rule information sent by an SMF;
performing a transferring-related operation based on the QoS rule information.

In some embodiments, performing the transferring-related operation in step S91 includes at least one of:
performing the transferring-related operation based on a granularity of a QoS flow;
performing the transferring-related operation based on a granularity of a data flow;
performing the transferring-related operation based on a granularity of a PDU set; or performing the transferring-related operation based on a granularity of a data packet.

An embodiment of the present disclosure provides an information processing method, performed by a second network function, including:
performing the transferring-related operation based on a granularity of a QoS flow;
performing the transferring-related operation based on a granularity of a data flow;
performing the transferring-related operation based on a granularity of a PDU set; or performing the transferring-related operation based on a granularity of a data packet.

In an embodiment of the present disclosure, the optimization granularity may include a data flow, a PDU set or a data packet when the transferring-related operation is performed. For example, the second network function may perform transfer optimization for each data flow or each set of PDUs or each packet. For another example, the second network function may perform selective packet discarding for each data flow or each PDU set or each packet. For another example, the second network function may perform transfer optimization or selective packet discarding for at least one data flow or at least one PDU set or at least one data packet.

In this way, in the embodiments of the present disclosure, transfer optimization and/or selective packet discarding may be performed on the service data based on the measurement result by using different granularities, thereby effectively relieving transferring of the service data during network congestion in more application scenarios.

In some embodiments, S91 includes at least one of:
performing the transferring-related operation within a predetermined time window;
performing the transferring-related operation based on a data flow traffic being greater than a traffic threshold; or
performing the transferring-related operation based on a packet error rate being greater than a packet error rate threshold.

An embodiment of the present disclosure provides an information processing method, performed by a second network function, including at least one of:
performing the transferring-related operation within a predetermined time window;
performing the transferring-related operation based on a data flow traffic being greater than a traffic threshold; or
performing the transferring-related operation based on a packet error rate being greater than a packet error rate threshold.

For example, the rule information indicates that a transferring-related operation should be performed within a predetermined time window, and the second network function performs the transferring-related operation in response to determining that a current time is within the predetermined time window.

For example, the rule information, for example, the data flow filtering rule information, indicates to perform the transferring-related operation when the traffic of the data flow is greater than the traffic threshold; and the second network function performs the transferring-related operation in response to determining that the traffic of the data flow of the network is greater than the traffic threshold.

For example, the rule information indicates to perform a transferring-related operation when the packet error rate is greater than the packet error rate threshold; and in response to determining that the packet error rate of the UE is greater than the packet error rate threshold, the second network function performs the transferring-related operation.

In this way, in the embodiments of the present disclosure, multiple optimization conditions, for example, a predetermined time window, a traffic threshold, and/or a packet error rate threshold, may be used to determine to perform the transferring-related operation, thereby effectively relieving transferring of service data when a network is congested in more application scenarios, and reducing inaccurate charging caused by packet discarding.

For details of the above implementation, reference may be made to the description on the AF side and/or the NEF side and/or the first network function side, and details will not be repeated herein.

It should be noted that those skilled in the art may understand that the method provided in the embodiments of the present disclosure may be performed separately, or may be performed together with some methods in the embodiments of the present disclosure or some methods in related technologies.

To further describe any embodiment of the present disclosure, several specific examples are provided below.

### Example 1

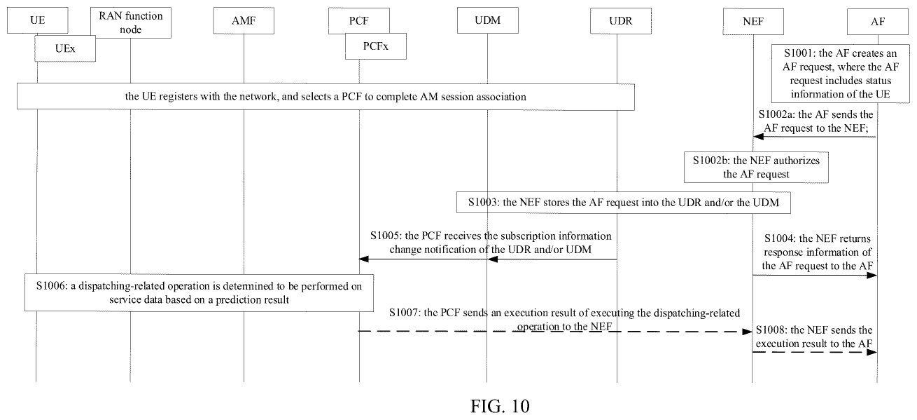

As shown in FIG. 10, an embodiment of the present disclosure provides an information processing method, performed by a communication device, where the communication device includes a UE, a RAN function node, an AMF, a PCF, a UDM, a UDR, an NEF and an AF; the information processing method includes:
Step S1000, the UE registers with the network, and selects a PCF to complete AM session association.

The PCF may subscribe, based on subscription information or rule information (or QoS requirement) of a XRM service, to the UDR for requirement indication information or capability indication information of a transferring-related operation (for example, UPF transferring based on predictions) on the service data based on the prediction result. In an optional embodiment, if the XRM service or the XRM service group is associated with multiple PCFs, all the PCFs may subscribe to the UDR.
Step S1001: the AF creates an AF request, where the AF request includes status information of the UE.

In an optional embodiment, the AF request includes a parameter for determining the status information of the UE; and/or the AF request includes requirement indication information and/or capability indication information.

The AF triggers Nnef_XRMServiceParameter service to create the AF request. The AF request may include the request information in the above embodiment.

In an optional embodiment, the AF request includes an XRM service identifier or an XRM service group identifier. The AF provides XRM service or multiple data service specific parameters to the service-related single or multiple UEs through Nnef_XRMServiceParameter service. The status information of the UE sent by the AF includes at least one of service description, service parameters, a UE or UE group identifier, and subscription to events. Specifically, Service Description. For identifying an XRM service or an XRM data service; the XRM service or the XRM data service may be identified by using a combination of a data network name (DNN) and network slice selection assistance information (S-NSSAI), or XRM identifier information; or may be identified by using an AF service identifier (AF-Service-Identifier) or an external application identifier.

Service Parameters. Service parameters refer to related QoS parameters on the AF guidance for XRM service or multimodal data service, for example, parameters such as a list of rules that associate XRM service or multimodal data service application traffic, UE policy, group identifier information, or combination of DNN and S-NSSAI, SSC (Session and Service Continuity) mode, alternative QoS parameters and priorities, and selection priorities of corresponding rules (for example, corresponding location or time window priorities, and corresponding access types or routing priorities).

UE or UE group identifier, for example, the XRM service associated with the AF request or a single UE or multiple UEs (Group UEs) associated with multiple data services.

Subscription to events. The AF may subscribe to notifications about enforcement and alteration of outcome of the SM policy, or AM policy or UE policy.

When the AF needs to update and delete a corresponding request or subscription, the AF may also initiate an update and deletion procedure of the AF request through the service.
Step S1002a: the AF sends the AF request to the NEF;
Step S1002b: the NEF authorizes the AF request;

The NEF performs a mapping operation, for example, mapping the external to the CN identifier.
Step S1003: the NEF stores the AF request into the UDR and/or the UDM.

In an optional embodiment, the NEF stores the AF to the UDR and/or the UDM and/or the AUSF, which may be stored as an AMF-associated parameter and/or an SMF-associated parameter and/or service characteristic parameter of the application data.

In an optional embodiment, the NEF refines the corresponding service parameter based on the local configuration. For example, based on an operator policy and subscription information, for an XRM service or a multimodal data service of a single UE or multiple UEs, it is determined whether to request a service characteristic to be authorized, and store corresponding parameters in the UDR.

If multiple UEs are involved, the NEF may transmit the requirement indication information or the capability indication information of the transferring-related operation of the prediction result on the service data to the PCFs, and perform corresponding authorization and policy and rule decision or update in each PCF. The PCF stores the corresponding information in the UDR according to the result of the request authorization. The NEF may directly transmit the group identifier to the PCF associated with the group identifier, or store the group identifier in the UDR and/or the UDM and/or the AUSF and then transmit the group identifier to the PCF associated with the group identifier through the subscription report.

In an optional embodiment, for a multi-UE scenario, subscription data of UE group members is associated by using XRM service identifier information or UE group identifier information, and data groups of the UE group are consistent (for example, characteristic parameters of QoS, access and data routing of a service).

The PCF may subscribe to a trigger event related to a related XRM service or multimodal data by the NEF, for example, a requirement or capability of a prediction result for a transferring-related operation on service data, a service QoS update, UE migration, or PCF change.

The PCF obtains, by receiving the AF request from the NEF, the requirement indication information or the capability indication information of the transferring-related operation of the service data corresponding to the prediction result. Optionally, coordination of policies such as QOS update is performed, for example, if a QoS characteristic parameter of UE1 changes in an XRM service or a multimodal data group, an event record is triggered to be recorded in the NEF, and is forwarded to another UE corresponding to the XRM service or the multimodal data group or a PCF associated with another application data flow of the same UE, to perform corresponding session update.
Step S1004: the NEF returns response information of the AF request to the AF.
Step S1005: the PCF receives the subscription information change notification of the UDR and/or UDM.

In an optional embodiment, a manner in which the PCF obtains the requirement indication information and/or the capability indication information from the AF includes: the PCF obtains the requirement indication information and/or the capability indication information from the AF, or obtains, by the NEF, the requirement indication information and/or the capability indication information sent by the third-party AF or the untrusted AF, or obtains, by the TSCTSF, the requirement indication information and/or the capability indication information sent by the AF or the NEF; after the UE registers with the network, the AF obtains the status information of the UE from the UE.
Step S1006: a transferring-related operation is determined to be performed on service data based on a prediction result.

In an optional embodiment, the PCF and/or the SMF generates rule information based on the requirement indication information and/or the capability indication information, and performs transfer optimization and/or selective packet discarding (for example, initiative selective packet discarding triggered by an event such as congestion, the initiative packet discarding herein refers to that a related network function determines by itself whether to discard the data packet or not) on the XRM data; and the PCF and/or the SMF sends the rule information to the UPF. The UPF installs rule information generated and delivered by the PCF and/or SMF, and performs transfer optimization and/or selective packet discarding on the XRM data.

The granularity of optimization may include: a QoS flow, a data flow, a PDU set or a data packet; and/or a condition of optimization may include: predetermined time window, predetermined traffic threshold or predetermined packet error rate (packet error rate threshold).

The prediction result based on by the UPF may include a prediction analysis result of a NWDAF, or an event notification result reported by a radio access network function node, or both.
Step S1007: the PCF sends an execution result of executing the transferring-related operation to the NEF.

In a scenario of multiple PCFs, the PCF may directly trigger another PCF to perform QoS change; or after storing the requirement indication information and/or the capability indication information or the XRM service group policy to the UDR and/or the UDM, the PCF triggers subscription to the UDM and/or the UDR and/or the NEF to report the requirement indication information and/or the capability indication information to a corresponding PCF, and performs XRM service group policy change.
Step S1008: the NEF sends the execution result to the AF.

### Example 2

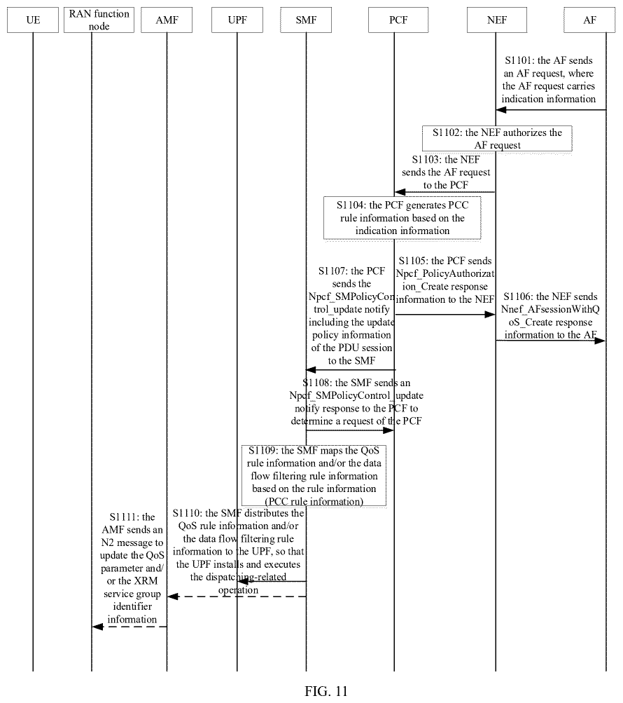

As shown in FIG. 11, an embodiment of the present disclosure provides an information processing method, performed by a communication device, where the communication device includes a UE, a RAN function node, an AMF, an SMF, a PCF, a UPF, an NEF and an AF. The information processing method includes:
Step S1101: the AF sends an AF request, where the AF request carries indication information.

The indication information is the indication information in the above embodiments. The request information further carries status information of the UE. The AF request may be the request information in the above embodiments.
Step S1102: the NEF authorizes the AF request.
Step S1103: the NEF sends the AF request to the PCF.

The NEF authorizes the AF request and determines whether to invoke the TSCTSF or directly contact the PCF according to parameters provided by the AF. These signaling steps are the same as TS 23.502 clause 4.15.6.6 for establishing AF sessions with required QoS procedures. The PCF receives the AF-provided attributes from the NEF or TSCTSF.
Step S1104: the PCF generates PCC rule information based on the indication information.

The PCF triggers Npcf_SMPolicyControl_UpdateNotify, and updates the rule information of the PDU session corresponding to the SMF, including PCC rule information and QOS rule information related to the AF request.
Step S1105: the PCF sends Npcf_Policy Authorization_Create response information to the NEF.
Step S1106: the NEF sends Nnef_AFsession WithQoS_Create response information to the AF.
Step S1107: the PCF sends the Npcf_SMPolicyControl_update notify including the update policy information of the PDU session to the SMF.

In an optional embodiment, the PCF sends the indication information to the SMF, and sends the rule information to the SMF.
Step S1108: the SMF sends an Npcf_SMPolicyControl_update notify response to the PCF to determine a request of the PCF.
Step S1109: the SMF maps the QoS rule information and/or the data flow filtering rule information based on the rule information (PCC rule information).
Step S1110: the SMF distributes the QoS rule information and/or the data flow filtering rule information to the UPF, so that the UPF installs and executes the transferring-related operation.
Step S1111: the AMF sends an N2 message to update the QoS parameter and/or the XRM service group identifier information.

The SMF uses the PCC rule information received in step 1107 to determine an authorized QoS flow of the QoS flow, and initiates a network-requested PDU session modification procedure to provide the NG-RAN (via the AMF) with updated QoS parameters and XRM service group information (XRM service group identifier information, etc.) of the related service flow. After receiving the information, the NG-RAN will apply the information in the traffic flow.

### Example 3

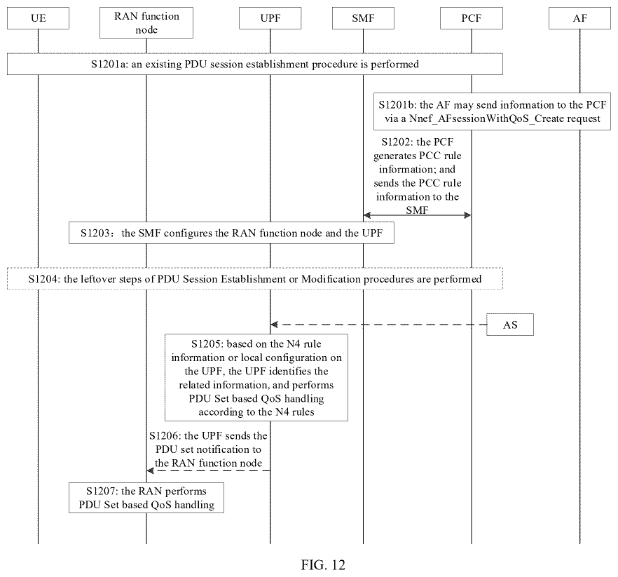

In some application scenarios, a PDU set-based policy and charging control may occur during the establishment or modification of a PDU session. As shown in FIG. 12, an embodiment of the present disclosure provides an information processing method, performed by a communication device, where the communication device includes a UE, a RAN function node, an AMF, an SMF, a PCF, a UPF, and an AF.
Step S1201a: an existing PDU session establishment procedure is performed;
Step S1201b: the AF may send information to the PCF via a Nnef_AFsession WithQoS_Create request;
where the information may be QoS parameters for each PDU Set within the QoS flow and/or parameters on frame identification. The AF may also provide this information to 5GS prior to PDU session establishment.

The QoS parameters for each PDU Set within the QoS flow includes at least one of:

PDU Set handling indication, where the PDU Set handling indication indicates whether PDU Set based handling should be activated to a data flow;
a parameter indicating whether all PDUs are needed for the usage of PDU Set by application layer;
PDU Set Delay Budget (PSDB); or
PDU Set Error Rate.

The parameters on frame identification includes burst periodicity.
Step S1202: the PCF generates PCC rule information; and sends the PCC rule information to the SMF;
where the PCC rule information may include QoS parameters. The PCF and/or SMF generates the rule information, and performs transfer optimization or selective flow control (for example, initiative packet discarding triggered by an event such as congestion) on downlink XRM data flows; where a prediction result of UPF transferring may be a network analysis result (network congestion) of the NWDAF (Network Data Analytics Function), or an event notification result (for example, network congestion) reported by the RAN function node, and the PCF determines to generate the PCC rule information by considering the prediction result.

The PDU Set related QoS parameters are new QoS parameters for PDU Set based QoS handling in 5GS, and the QoS parameters include at least one of:
PDU Set Delay Budget (PSDB); or
PDU Set Error Rate;
a parameter indicating whether all PDUs are needed for the usage of PDU Set by application layer;
a parameter indicating whether to discard a PDU Set in case PSDB is exceeded; or PDU Set priority or PDU priority. The “PDU Set priority” be the same for all PDU Sets (i.e. same as existing QoS Flow Priority), or it be different for each PDU Set (i.e. same as “PDU Set importance”).

This step is completed in step 7b in the PDU session establishment procedure, or is completed in step 1b in the PDU session modification procedure. (PDU Session Establishment procedure, PDU Session Modification procedure)

If this step is triggered by step 1b, the PCF generates the PCC rule information by considering the information provided by the AF.
Step S1203: the SMF configures the RAN function node and the UPF;

The SMF generates QoS profiles and N4 rule information based on the PCC rule information from the PCF. The SMF sends the N4 rule information to the UPF and sends the QoS profiles to the RAN function node via the AMF.

The steps are completed through a PDU session establishment procedure or a PDU session modification procedure.
Step S1204: the leftover steps of PDU Session Establishment or Modification procedures are performed;
Step S1205: based on the N4 rule information or local configuration on the UPF, the UPF identifies the related information, and performs PDU Set based QoS handling according to the N4 rules;
where related information on UPF identification includes at least one of:
rule information generated and delivered by the UPF based on a previously installed PCF and/or SMF; transfer optimization and/or selective packet discarding (for example, initiative and selective packet discarding triggered by an event such as congestion) are performed on downlink XRM data; a granularity for optimization may include: a QoS flow, a data flow, a PDU set, or a data packet; and/or a condition for optimization may include: a predetermined time window, a predetermined traffic threshold, or a predetermined packet discarding ratio (a packet error rate threshold).

The UPF identifies the PDUs belong to a PDU Set and the following information for each PDU Set:
PDU Set Sequence number (SN) (the QoS Flow is identified using QoS Flow identifier and each PDU Set within the QoS Flow is identified using PDU Set SN, each QoS Flow can be used to deliver one or more PDU Set);
Start/End PDU of the PDU Set;
PDU SN within a PDU Set; and
number of PDUs within a PDU Set.

Information for inter-PDU Set handling includes at least one of:
PDU Set importance; or
PDU Set dependency.

The UPF identifies the related information via the methods/mechanisms described, as follows:
Option 1: by matching RTP (Real-Time Transport Protocol)/SRTP (Secure Real-Time Transport Protocol) header and payload;
Option 2: new RTP extension header;
Option 3: by information provided by the AS (Access Stratum) in N6 encapsulation header e.g. GTP-U (GPRS Tunneling Protocol-User Plane);
Option 4: by detection based on traffic characteristics; and
Option 5: by non-standardized mechanisms UPF implementation.
Step S1206: the UPF sends the PDU set notification to the RAN function node;
where the UPF provides the above PDU Set related information (listed in the related information in step S1205) to the RAN function node.

For PDU Set importance relationship, optionally:
Option 1: the UPF classifies the DL (downlink) traffics into different QoS Flows based on PDU Set importance relationship;
Option 2: the UPF classifies the DL traffics into different sub-QoS Flows based on PDU Set importance relationship,
Option 3: the UPF adds the PDU Set importance relationship into GTP-U header.

For other PDU Set related information in step 5, the UPF adds them into GTP-U Header.
Step S1207: the RAN performs PDU Set based QoS handling.
where based on the PDU Set related information received in Step S1206, the RAN performs PDU Set based QoS handling.

If monitoring and reporting of the prediction condition are performed for the RAN function node, in a process of performing QoS handling (PDU set based QoS handling) of the PDU set by the RAN function node, when a packet discarding trigger event (for example, a congestion level is greater than a threshold, a packet error rate is greater than a threshold, a delay is greater than a threshold, and a status-related requirement of the UE) is detected, packets discarding event information and/or post-packets discarding indication information of a QoS handling data packet of the PDU set are reported to a core network (CN); for the PCF to generate and update corresponding rule information. The packet discarding event information indicates a trigger condition for discarding of downlink traffic of the XRM service that achieves condition, for example, congestion, status information of the UE (overheating information indicating overheating of the UE, information indicating a power mode, and information indicating GPU load balancing).

It should be noted that those skilled in the art may understand that the method provided in the embodiments of the present disclosure may be performed separately, or may be performed together with some methods in the embodiments of the present disclosure or some methods in related technologies.

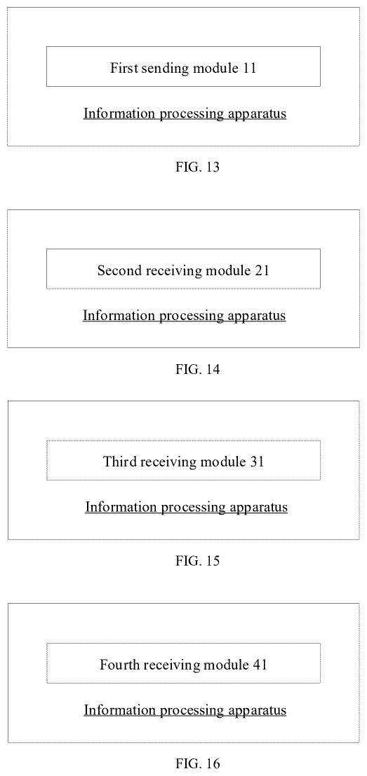

As shown in FIG. 13, an embodiment of the present disclosure provides an information processing apparatus, including:
a first sending module 11, configured to send indication information to a first network function, where the indication information is configured to indicate the first network function, or a second network function, or both, to perform a transferring-related operation on service data based on a prediction result; where the transferring-related operation includes transfer optimization, or selective packet discarding, or both.

The information processing apparatus provided in the embodiments of the present disclosure may include an AF.

In some embodiments, the indication information includes at least one of:
requirement indication information, indicating whether performing the transferring-related operation on the service data based on the prediction result is required; or
capability indication information, indicating whether performing the transferring-related operation on the service data based on the prediction result is supported.

An embodiment of the present disclosure provides an information processing apparatus, including:
a first receiving module, configured to receive the capability indication information sent by a user equipment (UE);
and/or, a first processing module, configured to determine the requirement indication information.

An embodiment of the present disclosure provides an information processing apparatus, including: a first sending module 11, configured to send request information carrying the indication information to the first network function, where the request information further includes status information of a UE, or a parameter for determining the status information of the UE; where the status information of the UE or the parameter for determining the status information of the UE is used for updating a QoS parameter by the first network function.

An embodiment of the present disclosure provides an information processing apparatus, including: a first sending module 11, configured to perform at least one of:
sending the indication information to the first network function in a service specific information provisioning procedure;
sending the indication information to the first network function in an AF session establishment procedure; or
sending the indication information to the first network function in an AF session modification procedure.

An embodiment of the present disclosure provides an information processing apparatus, including: a first sending module 11, configured to send indication information to a first network function through an NEF.

An embodiment of the present disclosure provides an information processing apparatus, including: the first network function including a PCF or an SMF; and/or the second network function including a UPF.

As shown in FIG. 14, an embodiment of the present disclosure provides an information processing apparatus, including:
a second receiving module 21, configured to receive indication information sent by an AF, where the indication information is configured to indicate a first network function, or a second network function, or both, to perform a transferring-related operation on service data based on a prediction result; where the transferring-related operation includes transfer optimization, or selective packet discarding, or both.

The information processing apparatus provided in the embodiments of the present disclosure may include an NEF.

In some embodiments, the apparatus includes: a second sending module, configured to send the indication information to the first network function.

In some embodiments, the indication information includes at least one of:
requirement indication information, indicating whether performing the transferring-related operation on the service data based on the prediction result is required; or
capability indication information, indicating whether performing the transferring-related operation on the service data based on the prediction result is supported.

An embodiment of the present disclosure provides an information processing apparatus, including:
The second receiving module 21 is configured to receive request information carrying the indication information sent by the AF;
the second sending module is configured to: in response to determining that a request indicated by the request information is authorized, send the indication information to the first network function.

An embodiment of the present disclosure provides an information processing apparatus, including: a second receiving module 21, configured to receive request information carrying the indication information sent by the AF, where the request information further includes service group identifier information, or user group identifier information, or both;
a second processing module, configured to: based on a case that there are more than one first network functions, determine, based on the service group identifier information, or the user group identifier information, or both, one of the first network functions to send the indication information.

An embodiment of the present disclosure provides an information processing apparatus, including: a second sending module, configured to perform at least one of:
send the indication information to a UDR, where the indication information is for storing by the UDR;
send the indication information to a UDM, where the indication information is for storing by the UDM; or
send the indication information to an AUSF, where the indication information is for storing by the AUSF;

As shown in FIG. 15, an embodiment of the present disclosure provides an information processing apparatus, including:
a third receiving module 31, configured to receive indication information sent by an AF, where the indication information is configured to indicate a first network function, or a second network function, or both, to perform a transferring-related operation on service data based on a prediction result; where the transferring-related operation includes transfer optimization, or selective packet discarding, or both.

The information processing apparatus provided in the embodiments of the present disclosure may be a first network function.

In some embodiments, the indication information includes at least one of:
requirement indication information, indicating whether performing the transferring-related operation on the service data based on the prediction result is required; or
capability indication information, indicating whether performing the transferring-related operation on the service data based on the prediction result is supported.

An embodiment of the present disclosure provides an information processing apparatus, including: a third receiving module 31, configured to perform at least one of:
receiving the indication information sent by the AF in a service specific information provisioning procedure;
receiving the indication information sent by the AF in an AF session establishment procedure; or receiving the indication information sent by the AF in an AF session modification procedure.

An embodiment of the present disclosure provides an information processing apparatus, including: a third receiving module 31, configured to perform at least one of:
receiving the indication information sent by the AF through an NEF;
receiving the indication information sent by the AF through a TSCTSF; or receiving the indication information sent by the NEF through a TSCTSF.

An embodiment of the present disclosure provides an information processing apparatus, including: a third processing module, configured to generate rule information based on the indication information; where the rule information is used for performing the transferring-related operation.

An embodiment of the present disclosure provides an information processing apparatus, including: a third processing module, configured to perform the transferring-related operation based on the rule information.

An embodiment of the present disclosure provides an information processing apparatus, including: a third sending module, configured to perform at least one of:
sending the rule information to the second network function, where the rule information is configured to indicate the second network function to perform the transferring-related operation; or
sending the rule information to a radio access network function node, where the rule information is used by the radio access network function node to update a QoS parameter.

The embodiment of the present disclosure provides an information processing device, which is a PCF, including: a third processing module configured to generate PCC rule information based on indication information.

An embodiment of the present disclosure provides an information processing apparatus, including: a third sending module, configured to send PCC rule information to an SMF, where the PCC rule information is used by the SMF to determine QoS rule information.

An embodiment of the present disclosure provides an information processing apparatus, which is an SMF, including:
a third processing module, configured to generate QoS rule information mapped to the PCC rule information based on the PCC rule information; and
a third sending module, configured to send the QoS rule information to the second network function.

An embodiment of the present disclosure provides an information processing apparatus, including:
a third receiving module 31 is configured to receive request information carrying the indication information sent by the AF, where the request information further includes: status information of a UE, or a parameter for determining the status information of the UE; and
a third processing module, configured to update a QoS parameter based on the status information of the UE, or the parameter for determining the status information of the UE.

In some embodiments, the second network function includes a user plane function (UPF).

As shown in FIG. 16, an embodiment of the present disclosure provides an information processing apparatus, including:
a fourth receiving module 41, configured to receive rule information sent by a first network function, where the rule information is used for performing a transferring-related operation on service data based on a prediction result; where the transferring-related operation includes transfer optimization, or selective packet discarding, or both.

An embodiment of the present disclosure provides an information processing apparatus, including: a fourth processing module, configured to perform the transferring-related operation based on the rule information.

An embodiment of the present disclosure provides an information processing apparatus, including: a fourth processing module, configured to perform at least one of:
performing the transferring-related operation based on a granularity of a QoS flow;
performing the transferring-related operation based on a granularity of a data flow;
performing the transferring-related operation based on a granularity of a PDU set; or performing the transferring-related operation based on a granularity of a data packet.

An embodiment of the present disclosure provides an information processing apparatus, including: a fourth processing module, configured to perform at least one of:
performing the transferring-related operation within a predetermined time window;
performing the transferring-related operation based on a data flow traffic being greater than a traffic threshold; or
performing the transferring-related operation based on a packet error rate being greater than a packet error rate threshold.

In some embodiments, the prediction result includes a prediction analysis result of a NWDAF, or an event notification result reported by a radio access network function node, or both.

In some embodiments, the first network function includes a PCF or an SMF; and/or the second network function includes a UPF.

An embodiment of the present disclosure provides an information processing apparatus, including:
a fourth receiving module 41, configured to receive QoS rule information sent by the SMF;
the fourth processing module is configured to perform the transferring-related operation based on the QoS rule information.

An embodiment of the present disclosure provides an information processing system, including: an AF, an NEF, a first network function and a second network function, where the AF is used for executing the information processing method applied to any embodiment in the AF, the NEF is used for executing the information processing method applied to any embodiment in the NEF, the first network function is used for executing the information processing method applied to any embodiment in the first network function, or the second network function is used for executing the information processing method applied to any embodiment in the second network function.

It should be noted that those skilled in the art may understand that the apparatus provided in the embodiments of the present disclosure may be performed separately, or may be performed together with some apparatuses in the embodiments of the present disclosure or some apparatuses in related technologies.

Regarding the apparatus in the above embodiments, a specific manner for each module to perform an operation has been described in detail in the embodiments related to the method, and will not be repeated in detail herein.

An embodiment of the present disclosure provides a communication device, including:
a processor; and
a memory for storing a processor-executable instruction;
where the processor is configured to: execute the executable instruction to implement the information processing method according to any embodiment of the present disclosure.

In an embodiment, the communication device may include, but is not limited to, at least one of: the AF, the NEF, the first network function or the second network function. The first network function may include a PCF or an SMF, and the second network function may include a UPF.

The processor may include various types of storage media, the storage media are non-transitory computer storage media, and can continue to memorize information stored on the storage media after the user equipment is powered off.

The processor may be connected to the memory by using a bus or the like, and is configured to read an executable program stored in the memory, for example, at least one of the methods shown in FIG. 2 to FIG. 12.

An embodiment of the present disclosure further provides a computer storage medium is provided, where the computer storage medium stores a computer-executable program, and when the executable program is executed by a processor, the information processing method of any embodiment of the present disclosure is implemented. For example, at least one of the methods shown in FIGS. 2 to 12.

Regarding the apparatus or the storage medium in the above embodiments, a specific manner for each module to perform an operation has been described in detail in the embodiments related to the method, and will not be repeated in detail herein.

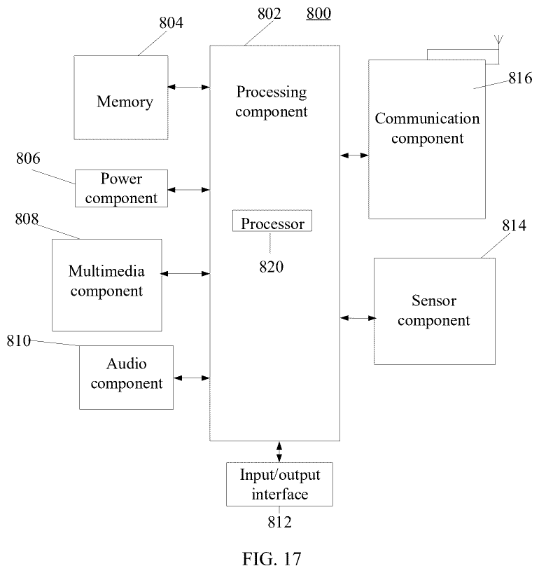

FIG. 17 is a block diagram of a user equipment (UE) 800 according to an example embodiment. For example, the UE 800 may be a mobile phone, a computer, a digital broadcast UE, a messaging device, a game console, a tablet device, a medical device, a fitness device, a personal digital assistant, or the like.

Referring to FIG. 17, the UE 800 may include one or more of: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as operations associated with display, telephone calls, data communications, camera operations, and recording operations. The processing component 802 may include one or more processors 820 to execute instructions to perform all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the UE 800. Examples of such data include instructions for any application or method operating on the UE 800, contact data, phonebook data, messages, pictures, videos, and the like. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 806 provides power for various components of the UE 800. The power component 806 may include a power management system, one or more power sources, and other components associated with generating, managing, and distributing power for the UE 800.

The multimedia component 808 includes a screen providing an output interface between the UE 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. When the UE 800 is in an operation mode, such as a photographing mode or a video mode, the front camera and/or the rear camera may receive external multimedia data. Each of the front camera and the rear camera may be a fixed optical lens system or have focal length and optical zoom capability.

The audio component 810 is configured to output and/or input audio signals. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and peripheral interface modules, which may be keyboards, click wheels, buttons, etc. These buttons may include, but are not limited to, home buttons, volume buttons, start buttons, and lock buttons.

The sensor component 814 includes one or more sensors for providing status assessments of various aspects of the UE 800. For example, the sensor component 814 may detect an open/closed state of the UE 800, relative positioning of components, such as a display and a keypad of the UE 800, a change in position of the UE 800 or a component of the UE 800, a presence or absence of user contact with the UE 800, an orientation or acceleration/deceleration of the UE 800, and a change in temperature of the UE 800. The sensor component 814 may include a proximity sensor configured to detect the presence of nearby objects without requiring any physical contact. The sensor component 814 may also include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 4G, or 5G, or a combination thereof. In an example embodiment, the communication component 816 receives a broadcast signal or broadcast related information from an external broadcast management system via a broadcast channel. In an example embodiment, the communication component 816 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example embodiment, the UE 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the above methods.

In an example embodiment, there is further provided a non-transitory computer-readable storage medium including an instruction, such as a memory 804 including the instruction, where the instruction is executable by a processor 820 of the UE 800 to perform the above method. For example, the non-transitory computer-readable storage medium may be a ROM (read-only memory), a RAM (random access memory), CD-ROM (compact disc read-only memory), magnetic tape, floppy disk, optical data storage device, or the like.

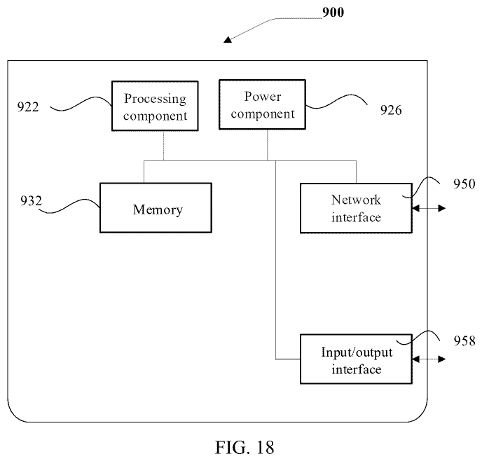

As shown in FIG. 18, an embodiment of the present disclosure shows a structure of a base station. For example, the base station 900 may be provided as a network-side device. Referring to FIG. 18, the base station 900 includes a processing component 922, which further includes one or more processors, and a memory resource represented by a memory 932 for storing instructions executable by the processing component 922, such as an application program. The application program stored in the memory 932 may include one or more modules each corresponding to a set of instructions. In addition, the processing component 922 is configured to execute instructions to perform any of the above methods applied to the base station.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in memory 932, such as Windows Server ™, Mac OS X™, Unix ™, Linux ™, FreeBSD™, or the like.

Other embodiments of the present disclosure will easily occur to those skilled in the art after considering the specification and practicing the present disclosure herein. The present disclosure is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. A method for information processing performed by an application function (AF), the method comprising:
sending indication information to a first network function, wherein the indication information is configured to indicate the first network function, or a second network function, or both, to perform a transferring-related operation on service data based on a prediction result; wherein the transferring-related operation comprises transfer optimization, or selective packet discarding, or both.

2. The method according to claim 1, wherein the indication information comprises at least one of:
requirement indication information, indicating whether performing the transferring-related operation on the service data based on the prediction result is required; or
capability indication information, indicating whether performing the transferring-related operation on the service data based on the prediction result is supported.

3. The method according to claim 2, wherein the method further comprises:
receiving the capability indication information sent by a user equipment (UE);
and/or,
determining the requirement indication information.

4. The method according to claim 1, wherein sending the indication information to the first network function comprises:
sending request information carrying the indication information to the first network function, wherein the request information further comprises status information of a UE, or a parameter for determining the status information of the UE; wherein the status information of the UE or the parameter for determining the status information of the UE is configured to indicate the first network function to update a quality of service (QOS) parameter based on the status information of the UE.

5. The method according to claim 1, wherein sending the indication information to the first network function comprises at least one of:
sending the indication information to the first network function in a service specific information provisioning procedure;
sending the indication information to the first network function in an AF session establishment procedure; or
sending the indication information to the first network function in an AF session modification procedure.

6. The method according to claim 1, wherein sending the indication information to the first network function comprises:
sending the indication information to the first network function through a network exposure function (NEF).

7. The method according to claim 1, wherein the first network function comprises a policy control function (PCF) or a session management function (SMF); and/or, the second network function comprises a user plane function (UPF).

8.-13. (canceled)

14. An method for information processing performed by a first network function, the method comprising:
receiving indication information sent by an application function (AF), wherein the indication information is configured to indicate the first network function, or a second network function, or both, to perform a transferring-related operation on service data based on a prediction result; wherein the transferring-related operation comprises transfer optimization, or selective packet discarding, or both.

15.-16. (canceled)

17. The method according to claim 14, wherein receiving the indication information sent by the AF comprises at least one of:
receiving the indication information sent by the AF through a network exposure function (NEF);
receiving the indication information sent by the AF through a time sensitive communication and time synchronization function (TSCTSF); or receiving the indication information sent by the NEF through a TSCTSF.

18. The method according to claim 14, wherein the method further comprises:
generating rule information based on the indication information, wherein the rule information is used for performing the transferring-related operation-; and
performing the transferring-related operation based on the rule information.

19. (canceled)

20. The method according to claim 18, wherein the method comprises at least one of:
sending the rule information to the second network function, wherein the rule information is configured to indicate the second network function to perform the transferring-related operation; or
sending the rule information to a radio access network function node, wherein the rule information is used by the radio access network function node to update a quality of service (QOS) parameter.

21. The method according to claim 18, wherein the first network function comprises a policy control function (PCF);
wherein generating the rule information based on the indication information comprises:
generating policy control and charging (PCC) rule information based on the indication information;
wherein the method further comprises:
sending the PCC rule information to a session management function (SMF), wherein the PCC rule information is used by the SMF to determine a QoS rule.

22. (canceled)

23. The method according to claim 21, wherein the first network function comprises a session management function (SMF);
the method further comprises:
generating QOS rule information mapped to the PCC rule information based on the PCC rule information; and
sending the rule information to the second network function comprises: sending the QoS rule information to the second network function.

24.-25. (canceled)

26. A method for information processing performed by a second network function, the method comprising:
receiving rule information sent by a first network function, wherein the rule information is used for performing a transferring-related operation on service data based on a prediction result; wherein the transferring-related operation comprises transfer optimization, or selective packet discarding, or both.

27. The method according to claim 26, wherein the method further comprises:
performing the transferring-related operation based on the rule information;
wherein the prediction result comprises a prediction analysis result of a network data analytics function (NWDAF), or an event notification result reported by a radio access network function node, or both.

28. The method according to claim 26, wherein performing the transferring-related operation comprises at least one of:
performing the transferring-related operation based on a granularity of a QoS flow;
performing the transferring-related operation based on a granularity of a data flow;
performing the transferring-related operation based on a granularity of a packet data unit (PDU) set flow; or
performing the transferring-related operation based on a granularity of a data packet.

29. The method according to claim 26, wherein performing the transferring-related operation based on the rule information comprises at least one of:
performing the transferring-related operation within a predetermined time window;
performing the transferring-related operation based on a data flow traffic being greater than a traffic threshold; or
performing the transferring-related operation based on a packet error rate being greater than a packet error rate threshold.

30.-31. (canceled)

32. The method according to claim 27, wherein receiving the rule information sent by the first network function comprises:
receiving QoS rule information sent by an SMF;
performing the transferring-related operation based on the rule information comprises:
performing the transferring-related operation based on the QoS rule information.

33.-36. (canceled)

37. A communication device, comprising:
a memory for storing a processor-executable instruction;
one or more processors that are communicatively coupled to the memory,
wherein the executable instruction when collectively executed by the one or more processors cause the communication device to perform the method according to claim 1.

38. A non-transitory computer storage medium, storing a computer-executable program, wherein when the computer-executable program is executed by a processor, cause the processor to perform the method according to claim 1.
